(19) United States
(12) Patent Application Publication
(10) Pub. No.: US 2026/0186377 A1
(43) Pub. Date: Jul. 2, 2026

(54) IMAGING APPARATUS

(71) Applicant: FUJIFILM Corporation, Tokyo (JP)

(72) Inventors: Masaaki TAKAGI, Saitama (JP); Keita KAMEI, Saitama (JP)

(73) Assignee: FUJIFILM Corporation, Tokyo (JP)

(21) Appl. No.: 19/417,292

(22) Filed: Dec. 11, 2025

(30) Foreign Application Priority Data
Dec. 27, 2024 (JP) 2024-231735

(51) Int. Cl. G03B 13/10; B08B 17/06

(52) U.S. Cl. CPC G03B 13/10; B08B 17/06

(57) ABSTRACT

There is provided an imaging apparatus with which it is possible to add a dial operation system while realizing size reduction achieved by reduction in height. The imaging apparatus includes a cover member that includes at least a first surface portion and a second surface portion intersecting the first surface portion, an accessory attachment portion provided at the first surface portion of the cover member, a finder portion in which an eyepiece portion is disposed at the second surface portion of the cover member, and an operation dial that is operated by being rotated around an axis intersecting the first surface portion. The operation dial is disposed between the accessory attachment portion and the finder portion and is disposed to be partially exposed through an opening portion provided at the second surface portion of the cover member.

### CROSS-REFERENCE TO RELATED APPLICATION

The present application claims priority under 35 U.S.C §119(a) to Japanese Patent Application No. 2024-231735 filed on December 27, 2024, which is hereby expressly incorporated by reference, in its entirety, into the present application.

### BACKGROUND OF THE INVENTION

### 1. Field of the Invention

The present invention relates to an imaging apparatus, and particularly to an imaging apparatus including an operation dial, an accessory attachment portion, and a finder portion.

### 2. Description of the Related Art

In the case of a rangefinder type camera or a camera (so-called rangefinder-style camera) having an appearance similar to the appearance of a rangefinder type camera, an upper cover portion is called a top deck portion (a colloquial name) and includes various operation members.

Described in each of JP2020-86098A and JP2003-295260A is a camera of which an upper cover portion includes a finder, a hot shoe (also called an accessory shoe), and various operation members. In particular, a configuration in which a diopter adjustment dial is disposed between a finder and a hot shoe is described in JP2020-86098A and a configuration in which a visual field frame switching lever is disposed between a finder and a hot shoe is described in JP2003-295260A.

### SUMMARY OF THE INVENTION

One embodiment according to the present disclosed technology provides an imaging apparatus with which it is possible to add a dial operation system while realizing size reduction achieved by reduction in height.

[1] An imaging apparatus including: a cover member that includes at least a first surface portion and a second surface portion intersecting the first surface portion; an accessory attachment portion provided at the first surface portion of the cover member; a finder portion in which an eyepiece portion is disposed at the second surface portion of the cover member; and an operation dial that is disposed between the accessory attachment portion and the finder portion, that is operated by being rotated around an axis intersecting the first surface portion, and that is partially exposed through an opening portion provided at the second surface portion of the cover member.

[2] The imaging apparatus according to [1], in which the cover member includes a recess portion provided at the second surface portion, and the opening portion is provided at the recess portion.

[3] The imaging apparatus according to [2], in which the recess portion extends in a direction intersecting a rotation axis of the operation dial.

[4] The imaging apparatus according to [2] or [3], further including: a sensor unit that detects use of the eyepiece portion, the sensor unit being provided at the second surface portion of the cover member, in which the sensor unit is disposed outside the recess portion.

[5] The imaging apparatus according to [4], in which the sensor unit includes a light emitting unit and a light receiving unit, and the light emitting unit and the light receiving unit are disposed to be arranged in a direction intersecting a rotation axis of the operation dial.

[6] The imaging apparatus according to any one of [1] to [5], further including: a window portion through which a disc surface of the operation dial is visible, the window portion being provided at the first surface portion of the cover member.

[7] The imaging apparatus according to [6], further including: a transparent or translucent window member provided at the window portion.

[8] The imaging apparatus according to [6] or [7], in which the window portion is disposed at a position separated from a rotation center of the operation dial.

[9] The imaging apparatus according to any one of [6] to [8], further including: an outer peripheral member that is disposed at an outer periphery of the operation dial in the cover member and that is visible through the window portion together with the operation dial.

The imaging apparatus according to [9], in which the outer peripheral member includes an indicator for the operation dial.

The imaging apparatus according to [9] or[10], in which the outer peripheral member includes a covering portion that covers at least a part of the operation dial.

The imaging apparatus according to [11], in which the operation dial includes an inclined surface provided at a peripheral edge of the disc surface, and the covering portion covers the inclined surface at least in a region visible through the window portion.

The imaging apparatus according to any one of [9] to [12], in which at least a region of the outer peripheral member that is visible through the window portion is composed of a surface aligned with the disc surface of the operation dial.

The imaging apparatus according to any one of [6] to [13], further including: foreign matter infiltration suppressing members that suppress infiltration of a foreign matter into the window portion, the foreign matter infiltration suppressing members being provided between the cover member and the operation dial.

The imaging apparatus according to [14], in which the foreign matter infiltration suppressing members include at least one of a first foreign matter infiltration suppressing member that surrounds a periphery of the window portion or a second foreign matter infiltration suppressing member that blocks a gap of the opening portion.

The imaging apparatus according to [15], in which the first foreign matter infiltration suppressing member has a frame-like shape that surrounds a region including a shaft portion of the operation dial.

The imaging apparatus according to [16], in which the first foreign matter infiltration suppressing member includes a first frame portion that surrounds the periphery of the window portion, and a second frame portion that surrounds a periphery of the shaft portion of the operation dial, and a distance from a rotation center of the operation dial to an inner periphery of the second frame portion is smaller than a distance from the rotation center of the operation dial to the window portion.

The imaging apparatus according to any one of [14] to [17], in which the foreign matter infiltration suppressing member is composed of a flocked member, a nonwoven fabric, or a foaming body.

The imaging apparatus according to any one of [1] to , in which the cover member includes a third surface portion that intersects the first surface portion and the second surface portion, and the imaging apparatus further includes a diopter adjustment dial for adjustment of a diopter of the finder portion, the diopter adjustment dial being provided at the third surface portion of the cover member.

The imaging apparatus according to any one of [1] to [18], in which the accessory attachment portion and the finder portion are disposed to be arranged in a direction intersecting an imaging optical axis.

An imaging apparatus including: a cover member that includes at least a first surface portion and a second surface portion intersecting the first surface portion; and an operation dial that is operated by being rotated around an axis intersecting the first surface portion and that is partially exposed through an opening portion provided at the second surface portion of the cover member, in which the cover member includes a window portion through which a disc surface of the operation dial is visible, the window portion being provided at the first surface portion.

### BRIEF DESCRIPTION OF THE DRAWINGS

FIG. 1 is a front view of a camera body.

FIG. 2 is a rear view of the camera body.

FIG. 3 is a top view of a camera body.

FIG. 4 is a right side view of the camera body.

FIG. 5 is a left side view of the camera body.

FIG. 6 is a perspective view of an upper cover portion of the camera body.

FIG. 7 is an enlarged plan view of an installation portion for an upper surface operation dial.

FIG. 8 is a view showing an example of the way in which the upper surface operation dial is operated.

FIG. 9 is an exploded perspective view of the upper cover portion of the camera body.

FIG. 10 is a plan view of the installation portion for the upper surface operation dial in the camera body.

FIG. 11 is a perspective half cross-sectional view of the upper surface operation dial and a decorative plate provided at a dial installation portion.

FIG. 12 is an enlarged view of a cross section of an installation portion for the decorative plate.

FIG. 13 is a plan view of a window member.

FIG. 14 is a plan view showing a configuration of a foreign matter infiltration suppressing mechanism.

FIG. 15 is a plan view showing another example of a window portion provided at an upper surface portion of an upper cover.

FIG. 16 is a perspective half cross-sectional view showing another example of the decorative plate.

FIG. 17 is a conceptual view of the way in which a wiring board is shared.

### DESCRIPTION OF THE PREFERRED EMBODIMENTS

Hereinafter, preferred embodiments of the present invention will be described in detail with reference to the attached drawings.

### Digital Camera

Here, a case where the present invention is applied to a camera body of a digital camera, particularly, a lens-interchangeable digital camera will be described as an example. The camera body is an example of an imaging apparatus.

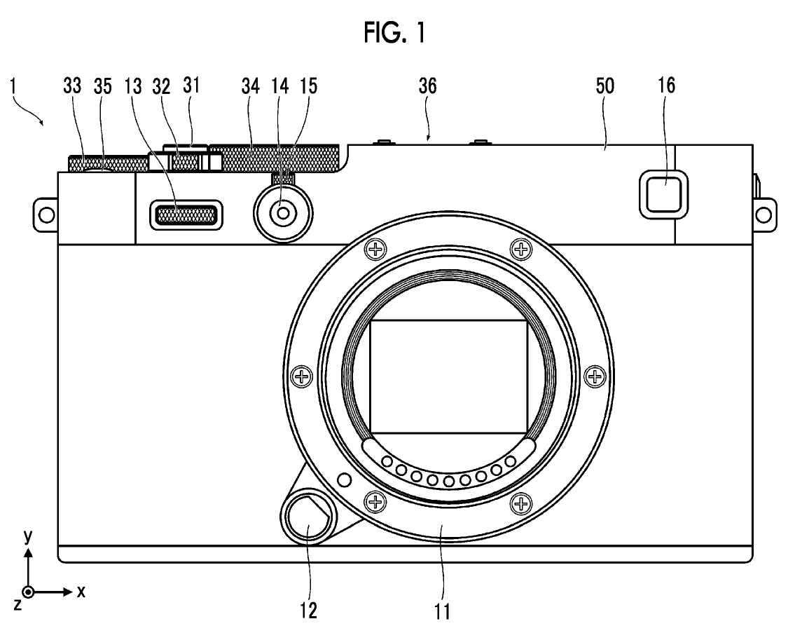

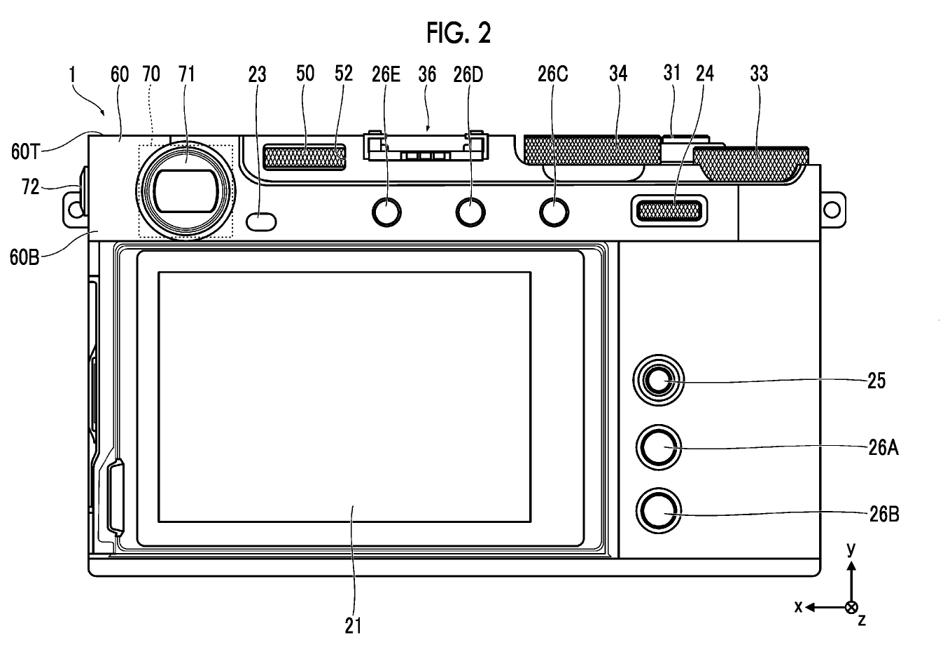

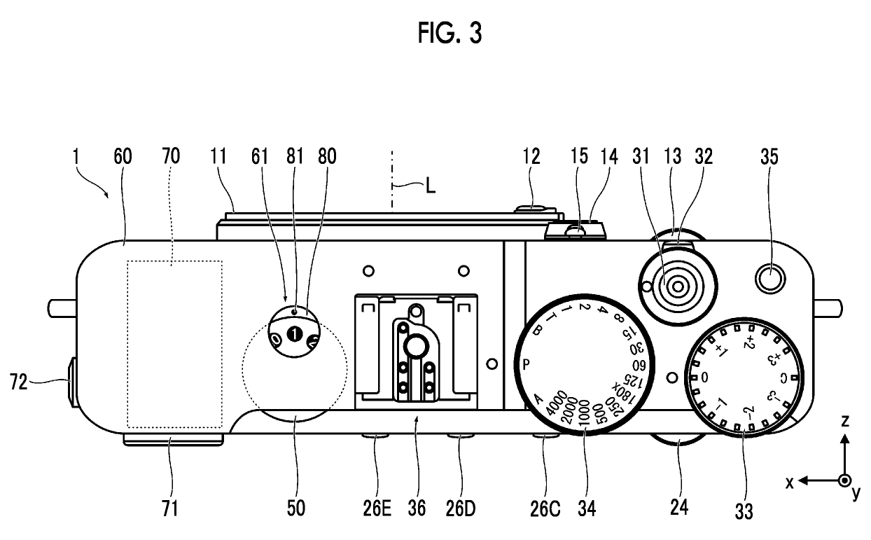

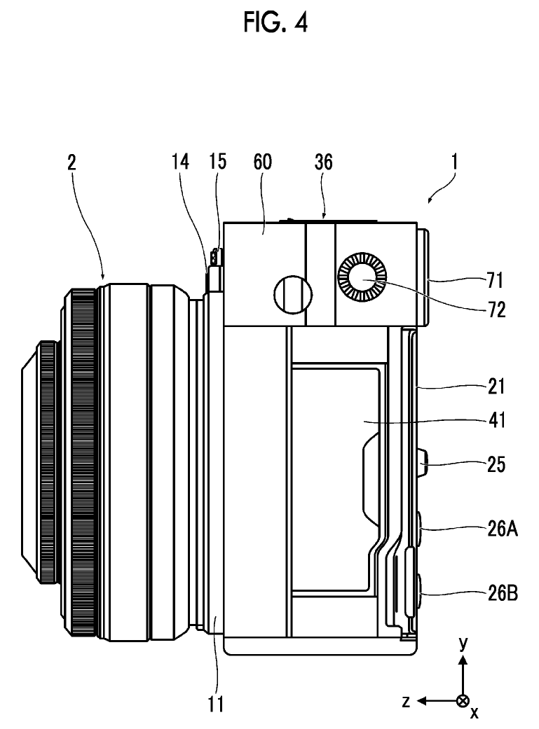

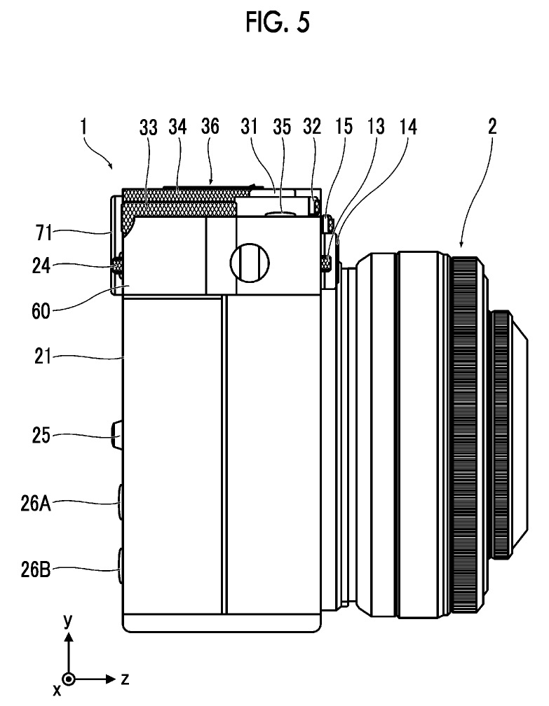

FIG. 1 is a front view of the camera body. FIG. 2 is a rear view of the camera body. FIG. 3 is a top view of the camera body. FIG. 4 is a right side view of the camera body. FIG. 5 is a left side view of the camera body. The right side view of FIG. 4 and the left side view of FIG. 5 show a state where an interchangeable lens 2 is mounted.

In FIGS. 1 to 5, an x-axis, a y-axis, and a z-axis are three axes orthogonal to each other. A direction along the x-axis will be referred to as a lateral direction, a direction along the y-axis will be referred to as a vertical direction, and a direction along the z-axis will be referred to as a front-rear direction. The lateral direction has the same meaning as a right-left direction or a horizontal direction. The vertical direction has the same meaning as an up-down direction or a perpendicular direction. The front-rear direction has the same meaning as a thickness direction. In addition, the front-rear direction is the same as a direction along an imaging optical axis L.

A camera body 1 shown in FIGS. 1 to 5 is a camera body of a lens-interchangeable mirrorless digital camera. A mirrorless digital camera refers to a digital camera without a mirror mechanism like a single-lens reflex camera.

As shown in FIGS. 1 to 5, the camera body 1 has a flat block-like shape (a rectangular parallelepiped-like shape), of which the thickness in the front-rear direction is large, as a whole and each of surfaces (a front surface, a rear surface, an upper surface, a bottom surface, a right surface, and a left surface) of the camera body 1 is composed of a substantially flat surface (having a so-called flat shape). Therefore, surfaces adjacent to each other are composed of surfaces orthogonal to each other. Being orthogonal to each other is an example of intersecting each other. The camera body 1 has a configuration in which the camera is operated after a left side portion as seen in a front view is gripped as a grip portion.

### Front Surface Portion of Camera Body

As shown in FIG. 1, a front surface of the camera body 1 includes a lens mount 11, a lens detachment button 12, a front surface operation dial 13, a front surface operation button 14, a front surface operation lever 15, an auto focus (AF) auxiliary light lamp 16, and the like.

The lens mount 11 is an attachment portion for an interchangeable lens. The lens detachment button 12 is a button (an unlocking button) for detachment of a lens attached to the lens mount 11.

The front surface operation dial 13 is a rotary operation member that is rotated around an axis parallel to the y-axis, and is disposed to be partially exposed at the front surface of the camera body 1. As shown in FIG. 1, the front surface operation dial 13 is disposed at a position corresponding to an upper left corner of the front surface of the camera body 1 as seen in a front view. This position is a position at which the front surface operation dial 13 can be operated by an index finger of a hand (a right hand) gripping the camera body 1 in general. The front surface operation dial 13 includes a click stop mechanism and is click-stopped at regular rotation angle intervals (the front surface operation dial 13 is rotationally operated with a click feeling).

The front surface operation button 14 is an operation member that is operated by being pressed. The front surface operation button 14 is disposed at a position that is to the right of the front surface operation dial 13 as seen in a front view and that is adjacent to the front surface operation dial 13. This position is a position at which the front surface operation button 14 can be operated by an index finger of a hand gripping the camera body 1 in general.

The front surface operation lever 15 is an operation member that is operated by being swung around an axis parallel to the z-axis. The front surface operation lever 15 is integrally provided with the front surface operation button 14 and is operated by being swung around the front surface operation button 14.

The AF auxiliary light lamp 16 is a lamp that emits AF auxiliary light (light for focus adjustment in a dark place). As shown in FIG. 1, the AF auxiliary light lamp 16 is disposed at a position corresponding to an upper right corner of the front surface of the camera body 1 as seen in a front view. The AF auxiliary light lamp 16 also functions as a self-timer lamp.

Predetermined functions are assigned to the front surface operation dial 13, the front surface operation button 14, and the front surface operation lever 15.

### Rear Surface Portion of Camera Body

As shown in FIG. 2, a rear surface of the camera body 1 includes a rear surface monitor 21, an eyepiece portion 71 of a finder, an eye sensor 23, a rear surface operation dial 24, a rear surface operation lever 25, a first rear surface operation button 26A, a second rear surface operation button 26B, a third rear surface operation button 26C, a fourth rear surface operation button 26D, a fifth rear surface operation button 26E, and the like.

The rear surface monitor 21 is a so-called tilt type monitor and is held via a tilt mechanism not shown in the drawing and the angle of the rear surface monitor 21 can be adjusted in the up-down direction. The rear surface monitor 21 is composed of, for example, a flat panel display (FPD) such as a liquid crystal display (LCD) and an organic EL display (organic light emitting diodes (OLED)).

The finder provided in the camera body 1 of the present embodiment is an electronic view finder (EVF), and an image as displayed on a display element (for example, an LCD, an OLED, or the like) is observed through the eyepiece portion 71. In the present embodiment, a finder unit 70 constituting the EVF is provided at an upper left corner of the camera body 1 as seen in a rear view. Accordingly, the eyepiece portion 71 is also provided at an upper left corner of the rear surface of the camera body 1. An installation portion for the finder unit 70 is an example of a finder portion.

The eye sensor 23 is a sensor used for the EVF. The eye sensor 23 detects approach of an eye to the eyepiece portion 71 to detect use of the EVF (use of the eyepiece portion 71). Accordingly, the eye sensor 23 is disposed adjacent to the eyepiece portion 71. In the present embodiment, as shown in FIG. 2, the eye sensor 23 is disposed at a position that is to the right of the eyepiece portion 71 and that is below the eyepiece portion 71 as seen in a rear view. The eye sensor 23 is an example of a sensor unit that detects use of the eyepiece portion 71.

The rear surface operation dial 24 is a rotary operation member that is rotated around an axis parallel to the y-axis, and is disposed to be partially exposed at the rear surface of the camera body 1. As shown in FIG. 2, the rear surface operation dial 24 is disposed at a position corresponding to an upper right corner of the rear surface of the camera body 1 as seen in a rear view. This position is a position at which the rear surface operation dial 24 can be operated by a thumb of a hand gripping the camera body 1 in general. The rear surface operation dial 24 includes a click stop mechanism and is click-stopped at regular rotation angle intervals.

The rear surface operation lever 25 is an operation member (a so-called joystick) with which it is possible to input a direction by tilting the operation member. In the present embodiment, the rear surface operation lever 25 is configured such that it is possible to input eight directions (an upward direction, a downward direction, a leftward direction, a rightward direction, a leftward and upward direction, a rightward and upward direction, a leftward and downward direction, and a rightward and downward direction). The rear surface operation lever 25 is disposed to the right of the rear surface monitor 21 as seen in a rear view. This position is a position at which the rear surface operation lever 25 can be operated by a thumb of a hand gripping the camera body 1 in general.

The first rear surface operation button 26A, the second rear surface operation button 26B, the third rear surface operation button 26C, the fourth rear surface operation button 26D, and a fifth rear surface operation button 26E are operation members that are operated by being pressed. The first rear surface operation button 26A and the second rear surface operation button 26B are disposed to be vertically arranged in a row in a region below the rear surface operation lever 25. The third rear surface operation button 26C, the fourth rear surface operation button 26D, and the fifth rear surface operation button 26E are disposed to be horizontally arranged in a row in a region above the rear surface monitor 21.

Predetermined functions are assigned to the rear surface operation dial 24, the rear surface operation lever 25, the first rear surface operation button 26A, the second rear surface operation button 26B, the third rear surface operation button 26C, the fourth rear surface operation button 26D, and the fifth rear surface operation button 26E, respectively.

### Upper Surface Portion of Camera Body

As shown in FIG. 3, an upper surface portion of the camera body 1 includes a shutter button 31, a power lever 32, an exposure correction dial 33, a shutter speed dial 34, an upper surface operation button 35, a hot shoe 36, an upper surface operation dial 50, and the like.

The shutter button 31 is composed of a two-stage push button that can be pressed halfway and fully. The shutter button 31 is provided at a position on a front side of a left end of an upper surface of the camera body 1 as seen in a front view. This position is a position at which the shutter button 31 can be operated by an index finger of a hand gripping the camera body 1 in general.

The power lever 32 is operated by being swung around an axis parallel to the y-axis. The power lever 32 is integrally provided with the shutter button 31 and is operated by being swung around the shutter button 31 between an ON position and an OFF position.

The exposure correction dial 33 is a rotary operation member used to set an exposure correction amount and is operated by being rotated around an axis parallel to the y-axis. In the present embodiment, the exposure correction dial 33 is configured such that the exposure correction can be performed in steps of one-third in a range of -3 to +3. The exposure correction dial 33 includes a click stop mechanism and is click-stopped at the position of each mark on a disc surface with respect to an indicator. The exposure correction dial 33 is provided at a position on a rear side of the left end of the upper surface of the camera body 1 as seen in a front view. This position is a position at which the exposure correction dial 33 can be operated by a thumb of a hand gripping the camera body 1 in general.

The shutter speed dial 34 is a rotary operation member used to set a shutter speed and is operated by being rotated around an axis parallel to the y-axis. In the present embodiment, the shutter speed dial 34 also serves as an exposure mode setting dial. In a case where a shutter speed value (B, T, 1 to 4000) on a disc surface is aligned with an indicator, the exposure mode is set to a shutter speed priority mode and the shutter speed is set in accordance with the value aligned with the indicator. Meanwhile, in a case where an icon "P" on the disc surface is aligned with the indicator, the exposure mode is set to a program mode. In addition, in a case where an icon "A" on the disc surface is aligned with the indicator, the exposure mode is set to an auto mode. The shutter speed dial 34 includes a click stop mechanism and is click-stopped at the position of each of the values and the icons on the disc surface with respect to the indicator. The shutter speed dial 34 is disposed at a position that is to the left of the exposure correction dial 33 as seen in a rear view and that is adjacent to the exposure correction dial 33. This position is a position at which the shutter speed dial 34 can be operated by a thumb of a hand gripping the camera body 1 in general.

The upper surface operation button 35 is an operation member that is operated by being pressed. The upper surface operation button 35 is disposed at a position that is to the left of the shutter button 31 as seen in a front view and that is adjacent to the shutter button 31. This position is a position at which the upper surface operation button 35 can be operated by an index finger of a hand gripping the camera body 1 in general.

The hot shoe 36 is a portion to which an external flash, an external finder, or the like is mechanically attached. The hot shoe 36 includes a contact point for electrical connection with an attached device. The hot shoe 36 is also called an accessory shoe. The hot shoe 36 is disposed at a substantially central position on the upper surface of the camera body 1. In the present embodiment, an installation portion for the hot shoe 36 is an example of an accessory attachment portion.

The upper surface operation dial 50 is a rotary operation member of which icons Ic1 to Ic10 printed on a disc surface 51 are aligned with an indicator 81 to set a predetermined function. The upper surface operation dial 50 is disposed in an exterior of the camera body 1 to be partially exposed. Specifically, the upper surface operation dial 50 is disposed in an upper cover 60 while an outer periphery of the upper surface operation dial 50 is partially exposed on a rear surface side. The upper cover 60 is a cover member of a so-called top deck portion and constitutes an exterior (an exterior of the upper surface portion and the vicinity of the upper surface portion) of the upper portion of the camera body 1. The upper surface operation dial 50 is operated by being rotated around an axis parallel to the y-axis by using a part of the upper surface operation dial 50 that is exposed on the rear surface side.

The upper cover 60 includes a window portion 61 corresponding to a position at which the upper surface operation dial 50 is disposed. How the upper surface operation dial 50 has been currently set is checked through the window portion 61. That is, the indicator 81 and an icon aligned with the indicator 81 are checked.

Since the upper surface operation dial 50 is disposed in the upper cover 60 as described above, a surface (an upper surface) of the upper cover 60 can be made flat at the position at which the upper surface operation dial 50 is disposed.

The upper surface operation dial 50 is disposed between the hot shoe 36 and the eyepiece portion 71 (between the hot shoe 36 and the finder unit 70). A rear surface portion 60B of the upper cover 60 includes an opening portion 62 corresponding to the position at which the upper surface operation dial 50 is disposed, and the upper surface operation dial 50 is disposed to be partially exposed through the opening portion 62.

In the present embodiment, the upper surface operation dial 50 is an example of an operation dial. Details of the upper surface operation dial 50 will be described later.

### Right Surface Portion of Camera Body

As shown in FIG. 4, a right surface portion of the camera body 1 includes a diopter adjustment dial 72, a terminal cover 41, and the like.

The diopter adjustment dial 72 is an operation member used to adjust the diopter (visibility) of the finder in accordance with the eyesight of a user. The diopter adjustment dial 72 is operated by being rotated around an axis parallel to the x-axis. The diopter adjustment dial 72 includes a click stop mechanism and is click-stopped at regular rotation angle intervals. The diopter adjustment dial 72 is disposed adjacent to the finder unit 70. Accordingly, in the present embodiment, the diopter adjustment dial 72 is disposed in the vicinity of an upper portion of the right surface portion of the camera body 1. In the present embodiment, the right surface portion of the camera body 1 (= a right surface portion of the upper cover 60) is an example of a third surface portion.

The terminal cover 41 is a cover that covers various terminals provided in the camera body 1. The terminal cover 41 is provided at the camera body 1 to be openable and closable.

### Details of Upper Surface Operation Dial

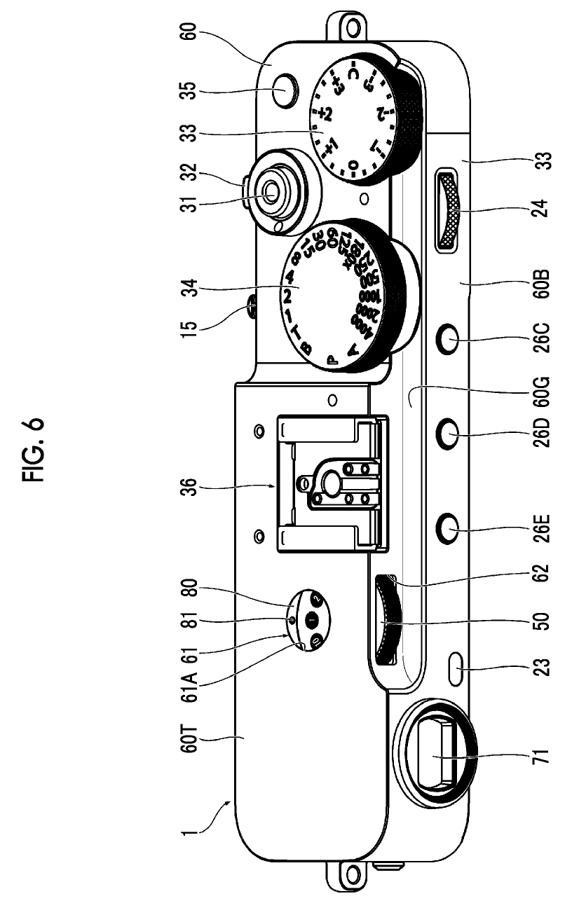

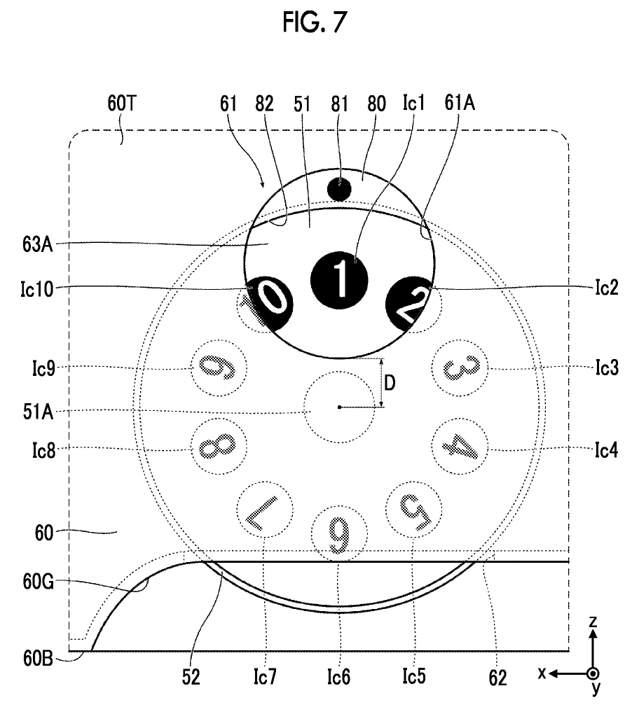

FIG. 6 is a perspective view of an upper cover portion (the top deck portion) of the camera body. In addition, FIG. 7 is an enlarged plan view of an installation portion for the upper surface operation dial.

As described above, the upper surface operation dial 50 is a rotary operation member of which the icons Ic1 to Ic10 printed on the disc surface 51 are aligned with the indicator 81 to set a predetermined function. For example, in the present embodiment, the image quality of an image to be captured is set by means of the upper surface operation dial 50. Specifically, the upper surface operation dial 50 is used to set the color development and gradation of an image to be captured (to set a function of switching the color reproduction and gradation expression of the image to be captured (film simulation)). Different settings (settings for color development and gradation) are assigned to the icons Ic1 to Ic10, respectively. In an example shown in FIG. 7, ten types of settings can be provided by means of the ten icons Ic1 to Ic10. Note that in FIG. 7, for convenience of description, the icons Ic1 to Ic10 are shown in the form of images of black circles with white numbers. It is preferable that images constituting the icons Ic1 to Ic10 are composed of images indicating what are set (characters, figures, symbols, and combinations thereof).

The upper surface operation dial 50 has a disk-like shape, and an upper surface (top surface) portion of the upper surface operation dial 50 constitutes the disc surface 51. A plurality of icons Ic1 to Ic10 are printed (the meaning of “being printed” includes “being engraved”) on the same circumference on the disc surface 51 at regular intervals. In the present embodiment, the ten icons Ic1 to Ic10 are printed at regular intervals (36-degree intervals).

The upper surface operation dial 50 of the present embodiment includes a shaft portion 51A provided at the center of the disc surface 51. The shaft portion 51A is disposed to slightly protrude from the disc surface 51 as a disk-shaped protrusion portion. The upper surface operation dial 50 rotates around the shaft portion 51A.

As described above, the upper surface operation dial 50 is disposed such that a part of the outer periphery of the upper surface operation dial 50 is exposed through the opening portion 62 provided at the rear surface portion 60B of the upper cover 60. A user operates the upper surface operation dial 50 by using the exposed part. In the present embodiment, the rear surface portion 60B of the upper cover 60 is an example of a second surface portion of the cover member.

As shown in FIG. 6, the upper cover 60 includes a groove-shaped recess portion 60G extending along an edge (a boundary between an upper surface portion 60T and the rear surface portion 60B) of the upper surface portion 60T that is on the rear surface side. The recess portion 60G has an arc-shaped cross-sectional shape in a cross section (a y-z cross section) orthogonal to the x-axis, and an end portion of the recess portion 60G is also rounded in an arc-like shape. In addition, the recess portion 60G is disposed over an area from a position between the upper surface operation dial 50 and the eyepiece portion 71 to the position of the exposure correction dial 33. A direction (an extending direction) in which the recess portion 60G extends coincides with a direction orthogonal to a rotation axis of the upper surface operation dial 50. The opening portion 62 is provided at the recess portion 60G.

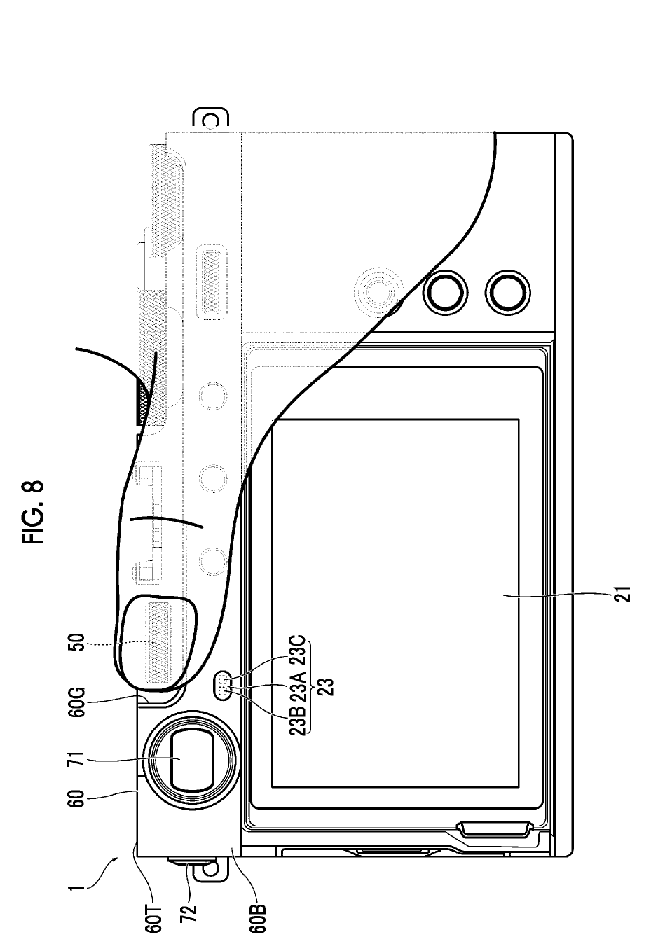

FIG. 8 is a view showing an example of the way in which the upper surface operation dial is operated.

Since the opening portion 62 is provided at the recess portion 60G extending in the direction orthogonal to the rotation axis of the upper surface operation dial 50, the recess portion 60G can be used as a guide for a finger in a case where the upper surface operation dial 50 is to be operated. That is, it is possible to operate the upper surface operation dial 50 by moving a finger along the recess portion 60G. Accordingly, the operability of the upper surface operation dial 50 can be improved.

Note that as shown in FIG. 8, the eye sensor 23 is disposed outside the recess portion 60G in the vicinity of the eyepiece portion 71. Accordingly, a finger operating the upper surface operation dial 50 is made less likely to be hooked on the eye sensor 23. That is, the malfunction (erroneous detection) of the eye sensor 23 caused in a case where the upper surface operation dial 50 is operated can be suppressed. In the present embodiment, the eye sensor 23 is disposed below the recess portion 60G as seen in a rear view, so that a finger operating the upper surface operation dial 50 is less likely to be hooked on the eye sensor 23.

Here, the eye sensor 23 of the present embodiment has a configuration in which a sensor window portion 23A having a long hole-like shape (a hole-like shape of which the vertical size and the horizontal size are different from each other) is provided and a light emitting unit 23B and a light receiving unit 23C are disposed inside the sensor window portion 23A. In a case where an object approaches the sensor window portion 23A such that a distance between the object and the sensor window portion 23A is made equal to or smaller than a certain distance, light emitted from the light emitting unit 23B collides with the approaching object, and light reflected from the object is received by the light receiving unit 23C. Accordingly, approach of an eye to the eyepiece portion 71 is detected. That is, use of the eyepiece portion 71 is detected.

As shown in FIG. 8, in the eye sensor 23 of the present embodiment, the light emitting unit 23B and the light receiving unit 23C are disposed to be horizontally arranged. That is, the light emitting unit 23B and the light receiving unit 23C are disposed to be arranged in the lateral direction (a direction along the x-axis) of the camera body 1. Therefore, the sensor window portion 23A also has a shape extending in the lateral direction of the camera body 1.

Note that the light emitting unit 23B and the light receiving unit 23C may be disposed to be vertically arranged. However, in a case where the light emitting unit 23B and the light receiving unit 23C are disposed to be horizontally arranged as in the present embodiment, the eye sensor 23 can be disposed farther from the upper surface operation dial 50 and thus erroneous detection can be more reliably suppressed.

An outer peripheral surface of the upper surface operation dial 50 is subjected to roughening (so-called knurling) and is composed of an uneven surface having a predetermined pattern. Accordingly, a finger operating the upper surface operation dial 50 can be made less likely to slip and improvement in operability can be achieved.

In addition, a peripheral edge (a corner portion which is a boundary between the disc surface and the outer peripheral surface) of the disc surface 51 of the upper surface operation dial 50 is composed of an inclined surface 52. That is, the corner portion is chamfered. As a result, it is possible to suppress the irritation to a finger operating the upper surface operation dial 50 and it is possible to provide a good operation feeling. For example, in the present embodiment, the peripheral edge of the disc surface 51 is composed of the linear inclined surface 52 (a so-called C-chamfered edge). Note that the peripheral edge may be composed of an arc-shaped inclined surface (a so-called R-chamfered edge).

The upper surface operation dial 50 includes a click stop mechanism and is click-stopped at the position of each of the icons Ic1 to Ic10 on the disc surface 51 with respect to the indicator 81.

As described above, how the upper surface operation dial 50 has been set is checked through the window portion 61 provided at the upper cover 60. That is, the icons Ic1 to Ic10 aligned with the indicator 81 are checked.

The window portion 61 is provided at the upper surface portion (top surface portion) 60T (= the upper surface portion of the camera body 1) of the upper cover 60. A region of the upper surface portion 60T in which the window portion 61 is provided is composed of a substantially flat surface including the installation portion for the hot shoe 36. In the present embodiment, the upper cover 60 is an example of a cover member. In addition, the upper surface portion 60T of the upper cover 60 is an example of a first surface portion of the cover member.

In the present embodiment, the window portion 61 is composed of a circle having a diameter smaller than the diameter of the upper surface operation dial 50, and is disposed at a position offset from the rotation center of the upper surface operation dial 50 (a position separated from the rotation center of the upper surface operation dial 50 by a distance D). Therefore, only a part of the disc surface 51 of the upper surface operation dial 50 is observed through the window portion 61. A region visible through the window portion 61 includes a region near the upper surface operation dial 50. The indicator 81 is provided in the region near the upper surface operation dial 50 which is observed through the window portion 61.

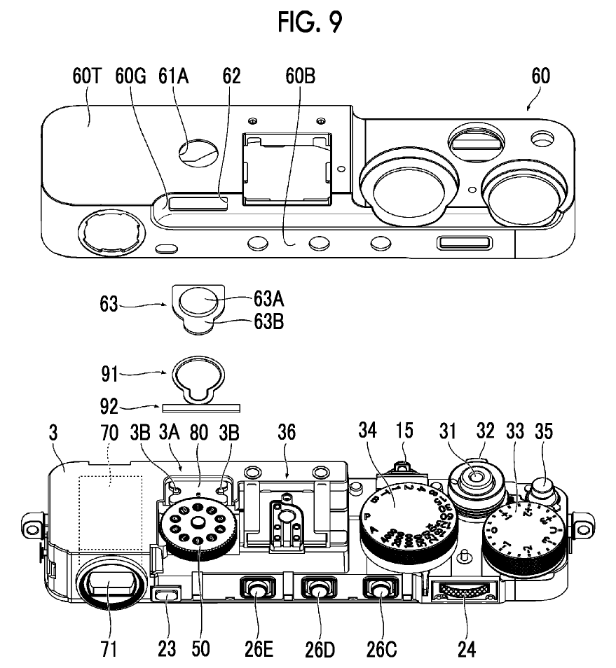

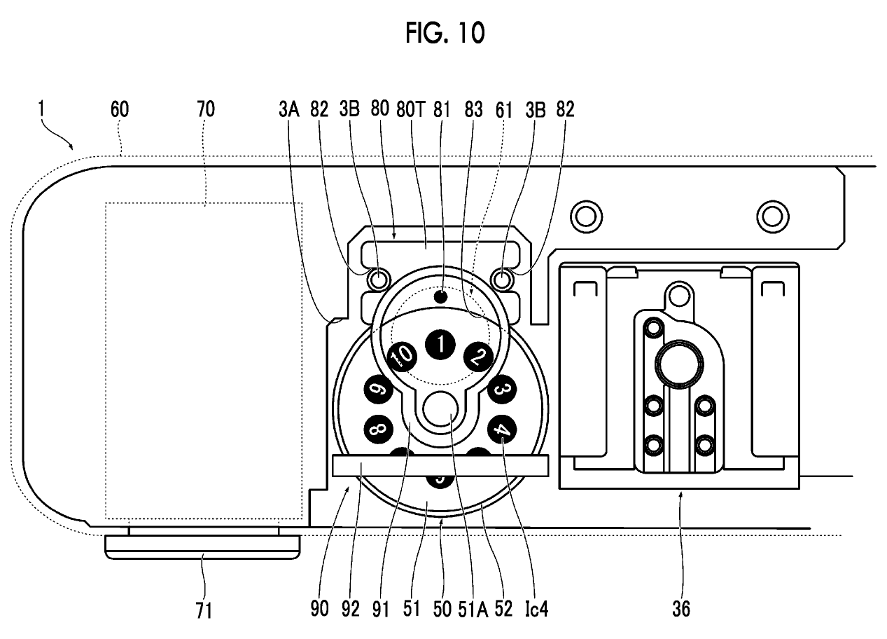

FIG. 9 is an exploded perspective view of the upper cover portion of the camera body. FIG. 10 is a plan view of an installation portion for the upper surface operation dial in the camera body.

As shown in FIGS. 9 and 10, in the camera body 1, the upper surface operation dial 50 is disposed between the installation portion for the hot shoe 36 and the installation portion for the finder unit 70. The installation portion for the hot shoe 36 and the installation portion for the finder unit 70 are disposed to be arranged in a direction (the direction along the x-axis) orthogonal to the imaging optical axis L. An internal frame 3 disposed inside the camera body 1 includes a dial installation portion 3A provided between the installation portion for the hot shoe 36 and the installation portion for the finder unit 70. The dial installation portion 3A is configured as a recess portion that can accommodate the upper surface operation dial 50.

A decorative plate 80 is disposed in a region of the dial installation portion 3A that is visible through the window portion 61. The decorative plate 80 has a thin plate-like shape of which an upper surface 80T (a surface visible through the window portion 61) is composed of a flat surface. The indicator 81 is disposed at a predetermined position on the upper surface 80T of the decorative plate 80. For example, in the present embodiment, the indicator 81 is composed of a disk-shaped protrusion (a protrusion portion) and is disposed to protrude from the upper surface 80T of the decorative plate 80.

The decorative plate 80 has a shape that is bilaterally symmetrical with respect to the indicator 81 and includes notch portions 82 provided at right and left edge portions. The dial installation portion 3A includes positioning pins 3B to be engaged with the right and left notch portions 82. In a case where the notch portions 82 are engaged with the positioning pins 3B, the decorative plate 80 is attached while being positioned at a predetermined position on the dial installation portion 3A. In addition, accordingly, the decorative plate 80 is attached while being positioned at a predetermined position on an outer periphery of the upper surface operation dial 50 in the upper cover 60. In the present embodiment, the decorative plate 80 is an example of an outer peripheral member.

The upper surface 80T of the decorative plate 80 attached to the dial installation portion 3A, is positioned on the same plane as the disc surface 51 of the upper surface operation dial 50. That is, the upper surface 80T of the decorative plate 80 and the disc surface 51 of the upper surface operation dial 50 are aligned with each other and are in a so-called flush state (a flat state in which there is no level difference between two surfaces). Since the upper surface 80T of the decorative plate 80 and the disc surface 51 of the upper surface operation dial 50 are disposed to be flush with each other, improvement in appearance quality can be achieved.

The decorative plate 80 has an arc portion 83 provided a portion that comes into contact with the upper surface operation dial 50 in a region observed through the window portion 61. The arc portion 83 has an arc-like shape extending along the outer periphery of the upper surface operation dial 50. Accordingly, the decorative plate 80 can be disposed at the outer periphery of the upper surface operation dial 50 with almost no gap, and improvement in appearance quality can be achieved. Furthermore, in the present embodiment, with the following configuration adopted with respect to the upper surface operation dial 50 including the inclined surface 52 (a chamfered portion) provided at the peripheral edge of the disc surface 51, a gap between the disc surface 51 and the upper surface 80T of the decorative plate 80 is minimized so that improvement in appearance quality is achieved.

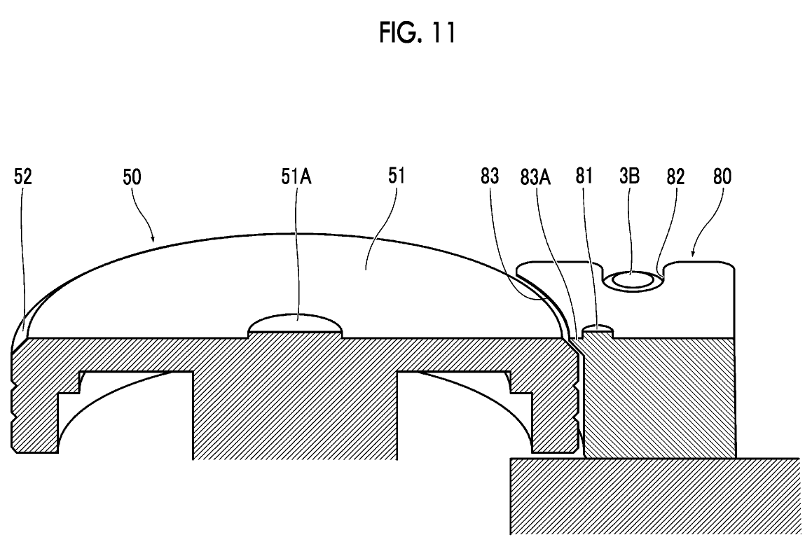

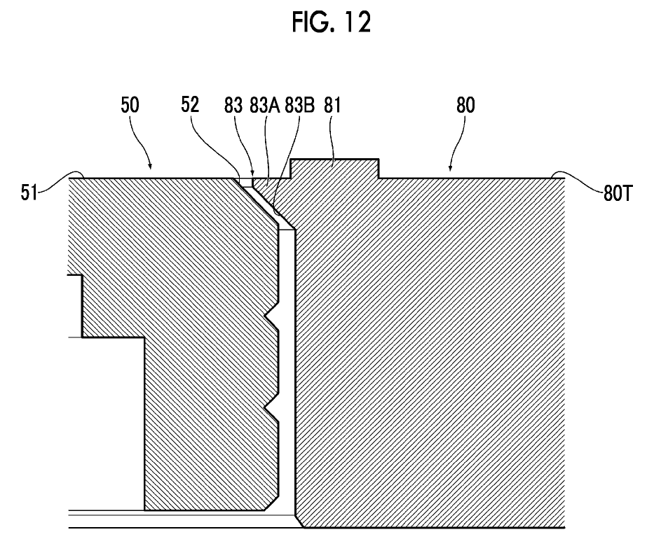

FIG. 11 is a perspective half cross-sectional view of the upper surface operation dial and the decorative plate provided at the dial installation portion. FIG. 12 is an enlarged view of a cross section of an installation portion for the decorative plate. Note that in FIG. 11, the disc surface (the icons) of the upper surface operation dial 50 is not shown for the sake of convenience.

As shown in FIGS. 11 and 12, the decorative plate 80 has a projecting portion 83A that projects in an eaves-like shape along an edge of the arc portion 83, and the projecting portion 83A is disposed to overlap with the inclined surface 52 of the upper surface operation dial 50. That is, a portion of the upper surface operation dial 50 that corresponds to the inclined surface 52 is covered with the projecting portion 83A of the decorative plate 80. Accordingly, a gap between the disc surface 51 of the upper surface operation dial 50 and the upper surface 80T of the decorative plate 80 as observed through the window portion 61 can be minimized. With reduction in size of the gap, improvement in appearance quality can be achieved.

In the present embodiment, the projecting portion 83A has a right-angled triangular cross-sectional shape, and an inclined surface 83B on a lower side in FIG. 12 is composed of a surface parallel to the inclined surface 52 of the upper surface operation dial 50. In the present embodiment, the projecting portion 83A is an example of a covering portion.

As described above, the window portion 61 in the present embodiment is composed of a circle having a diameter smaller than the diameter of the upper surface operation dial 50, and is disposed at a position offset from the rotation center of the upper surface operation dial 50 (a position separated from the rotation center of the upper surface operation dial 50 by the distance D). The window portion 61 is composed of a circular window opening portion 61A provided at the upper cover 60 and a transparent window member 63 attached to the window opening portion 61A.

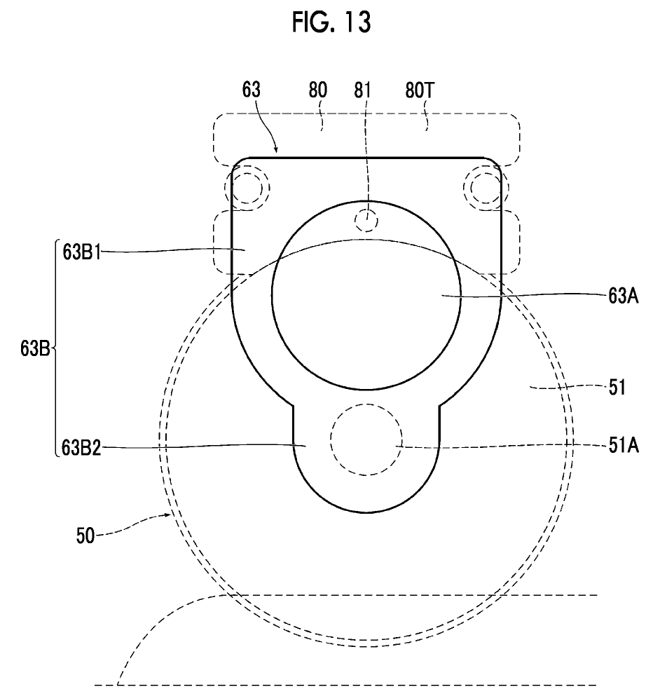

FIG. 13 is a plan view of the window member.

The window member 63 includes a window body portion 63A and a flange portion 63B. The window body portion 63A is a portion to be fitted to the window opening portion 61A. The window body portion 63A has an outer diameter corresponding to an inner diameter of the window opening portion 61A.

The window body portion 63A constitutes a cover (a transparent cover) of the window portion 61. A surface of the window body portion 63A fitted to the window opening portion 61A is positioned on the same plane as the upper surface portion 60T of the upper cover 60. That is, the surface is flush with the upper surface portion 60T of the upper cover 60. A user checks how the upper surface operation dial 50 has been set via the window body portion 63A. Although it is preferable that the window body portion 63A is transparent (the meaning of being transparent includes being considered as substantially transparent) from the viewpoint of visibility, the window body portion 63A may be translucent. For example, the window body portion 63A may be translucent by being colored or the like. In addition, the window body portion 63A may have a lens function.

The flange portion 63B functions as an attachment portion of the window member 63 with respect to the upper cover 60. The window member 63 is attached with the flange portion 63B bonded to an inner surface of the upper cover 60. For example, the flange portion 63B is attached to the inner surface of the upper cover 60 with double-sided tape.

The flange portion 63B includes a flange portion body 63B1 and a protruding portion 63B2 that extends toward the shaft portion 51A of the upper surface operation dial 50 from the flange portion body 63B1. The protruding portion 63B2 has a size enough to completely cover the shaft portion 51A and is disposed with a predetermined clearance provided between the protruding portion 63B2 and an upper surface of the shaft portion 51A. For example, in the present embodiment, the protruding portion 63B2 has a semicircular shape larger than the shaft portion 51A and is disposed above the shaft portion 51A with the predetermined clearance provided between the protruding portion 63B2 and the shaft portion 51A.

Note that for improvement in waterproof performance, it is preferable that packing (not shown) or the like is disposed between the window member 63 and the window opening portion 61A to seal a space between the window member 63 and the window opening portion 61A. For example, a configuration in which an O-ring is mounted around the window body portion 63A to seal the window portion 61 can be adopted.

As described above, the window member 63 is attached to the window portion 61 of the present embodiment, so that dustproof properties and waterproof properties are ensured. In addition, an installation portion for the window portion 61 can be flattened.

Meanwhile, it is difficult to remove a foreign matter such as dust infiltrating into the window portion 61 having a tightly closed structure as described above, which impairs the visibility.

Therefore, the camera body 1 of the present embodiment includes a mechanism (a foreign matter infiltration suppressing mechanism) that suppresses infiltration of a foreign matter into the window portion 61.

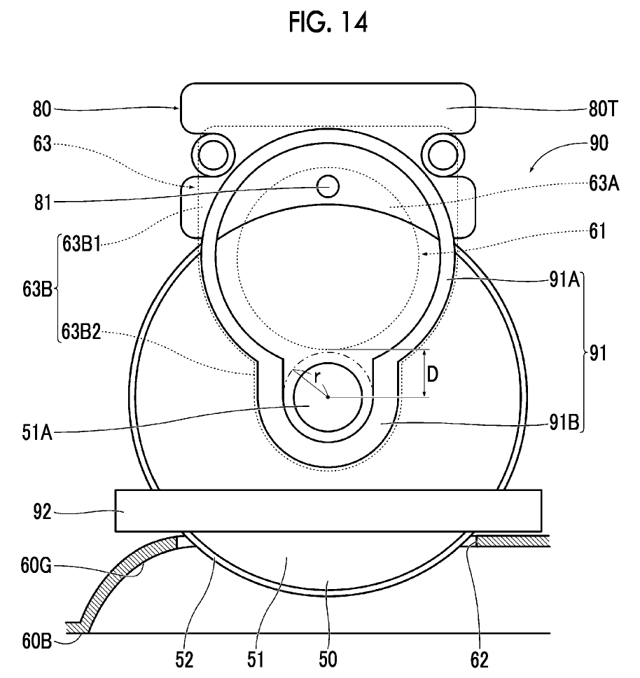

FIG. 14 is a plan view showing a configuration of a foreign matter infiltration suppressing mechanism. Note that for the sake of convenience, the disc surface (the icons) of the upper surface operation dial 50 is not shown.

In the present embodiment, a foreign matter infiltration suppressing mechanism 90 suppresses infiltration of a foreign matter into the window portion 61 with predetermined guard members disposed in a foreign matter infiltration route into the window portion 61. The guard members are examples of a foreign matter infiltration suppressing member.

In the present embodiment, two guard members, which are a first guard member 91 and a second guard member 92, are provided as the guard members. The first guard member 91 is an example of a first foreign matter infiltration suppressing member. In addition, the second guard member 92 is an example of a second foreign matter infiltration suppressing member.

The first guard member 91 surrounds a periphery of the window portion 61 at a position between an upper surface portion (a top surface portion) inside the upper cover 60 and the upper surface (the disc surface) of the upper surface operation dial 50 to suppress the direct infiltration of a foreign matter into the window portion 61. For example, the first guard member 91 of the present embodiment is composed of a frame (a frame-shaped member) consisting of a large-diameter portion 91A and a small-diameter portion 91B, and is composed of an elastic material (a material having cushioning properties). For example, in the present embodiment, the first guard member 91 is composed of a foaming body (a foaming material). For example, the first guard member 91 is composed of a polyethylene-based foaming body.

The large-diameter portion 91A of the first guard member 91 is a portion that surrounds the periphery of the window portion 61 and has an inner diameter larger than the inner diameter of the window portion 61 (the inner diameter of the window opening portion 61A).

The small-diameter portion 91B of the first guard member 91 is a portion that surrounds a periphery of the shaft portion 51A of the upper surface operation dial 50 and has an inner diameter larger than the outer diameter of the shaft portion 51A. In addition, in the present embodiment, a configuration is adopted in which an inner radius r (an inner radius of an arc portion) of the small-diameter portion 91B is smaller than a distance (a linear distance) D from the rotation center of the upper surface operation dial 50 to the window portion 61 (r < D).

In the present embodiment, the first guard member 91 is attached to the window member 63. More specifically, the first guard member 91 is attached to a lower surface portion of the flange portion 63B of the window member 63. For example, the first guard member 91 is attached by being bonded to the lower surface portion of the flange portion 63B with double-sided tape. As shown in FIG. 14, the first guard member 91 has an outer peripheral shape that substantially coincides with the outer peripheral shape of the flange portion 63B of the window member 63, and is disposed along the outer periphery of the flange portion 63B. In the present embodiment, the large-diameter portion 91A of the first guard member 91 is an example of a first frame portion, and the small-diameter portion 91B is an example of a second frame portion.

As described above, the window member 63 is attached to the upper cover 60 with the window body portion 63A fitted to the window opening portion 61A. Therefore, in a case where the window member 63 is attached to the upper cover 60, the first guard member 91 is also attached to the upper cover 60. The first guard member 91 attached to the upper cover 60 is disposed at a predetermined position in a case where the upper cover 60 is mounted to the camera body 1. That is, the first guard member 91 is disposed between the upper surface portion of the upper cover 60 and the upper surface (the disc surface) 51 of the upper surface operation dial 50 in the upper cover 60. In addition, the first guard member 91 is disposed to be pressed against the disc surface 51 of the upper surface operation dial 50 and the upper surface 80T of the decorative plate 80. That is, the first guard member 91 is disposed in a slightly compressed state. Accordingly, the first guard member 91 can surround the periphery of the window portion 61 with almost no gap. Infiltration of a foreign matter into the window portion 61 can be suppressed. In addition, since the first guard member 91 is pressed against the disc surface 51 and abuts against the disc surface 51, the disc surface 51 of the upper surface operation dial 50 is wiped by the first guard member 91 each time the upper surface operation dial 50 is operated. That is, the upper surface operation dial 50 is always operated by being operated with the disc surface 51 wiped by the first guard member 91. Accordingly, even in a case where a foreign matter that has infiltrated from the outside adheres to the disc surface 51 of the upper surface operation dial 50, the foreign matter can be wiped off by the first guard member 91 before the foreign matter infiltrates the window portion 61.

In addition, since the first guard member 91 of the present embodiment is configured to surround a region including the shaft portion 51A of the upper surface operation dial 50, even in a case where dust such as sliding powder (powdery dust generated due to contact between the shaft portion 51A rotating and another member) is generated at the shaft portion 51A, infiltration of the dust into the window portion 61 can be suppressed. In particular, regarding the first guard member 91 of the present embodiment, the inner radius r of the small-diameter portion 91B is smaller than the distance D from the rotation center of the upper surface operation dial 50 to the window portion 61. Therefore, infiltration of the dust can be effectively suppressed. That is, even in a case where the sliding powder spreads from the shaft portion 51A, the sliding powder can be wiped off before the sliding powder reaches the window portion 61, so that infiltration of dust (the sliding powder) into the window portion 61 can be suppressed.

The second guard member 92 blocks a gap of the opening portion 62 at a position between the upper surface portion (the top surface portion) inside the upper cover 60 and the upper surface (the disc surface) of the upper surface operation dial 50 to indirectly suppress infiltration of a foreign matter into the window portion 61. For example, the second guard member 92 of the present embodiment is composed of a bar-shaped plate (a plate-shaped member) extending along a longitudinal direction of the opening portion 62, and is composed of an elastic material (a material having cushioning properties). For example, in the present embodiment, the second guard member 92 is composed of a foaming body (a foaming material). For example, the second guard member 92 is composed of a polyethylene-based foaming body.

In the present embodiment, the second guard member 92 is attached to the upper surface portion inside the upper cover 60 to correspond to the position of the opening portion 62. For example, the second guard member 92 is attached by being bonded to the upper surface portion inside the upper cover 60 with double-sided tape. In a case where the upper cover 60 is mounted to the camera body 1, the second guard member 92 is disposed at a position in the upper cover 60 at which the second guard member 92 blocks the gap of the opening portion 62. More specifically, the second guard member 92 is disposed at a position at which the second guard member 92 blocks the gap formed between the opening portion 62 and the upper surface (the disc surface) 51 of the upper surface operation dial 50.

In addition, the second guard member 92 is disposed to be pressed against the disc surface 51 of the upper surface operation dial 50. That is, the second guard member 92 is disposed in a slightly compressed state. Accordingly, the second guard member 92 can be disposed with no gap with respect to the disc surface 51 of the upper surface operation dial 50. In addition, accordingly, infiltration of a foreign matter infiltrating onto the disc surface 51 of the upper surface operation dial 50 through the opening portion 62 can be suppressed.

In addition, since the second guard member 92 is pressed against the disc surface 51 of the upper surface operation dial 50 and abuts against the disc surface 51, the disc surface 51 of the upper surface operation dial 50 can be wiped as the upper surface operation dial 50 is operated by being rotated. Accordingly, even in a case where a foreign matter that has infiltrated from the outside adheres to the disc surface 51 of the upper surface operation dial 50, infiltration of the foreign matter can be suppressed by means of the second guard member 92.

Note that it is preferable that the first guard member 91 and the second guard member 92 that are pressed against the upper surface operation dial 50 and that abut against the upper surface operation dial 50 are formed of a material that is not easily deteriorated since a load caused by rotation of the upper surface operation dial 50 acts on the first guard member 91 and the second guard member 92.

### Operation and Effect of Upper Surface Operation Dial

As described above, the upper surface operation dial 50 of the present embodiment is disposed in the upper cover 60 to be partially exposed at the rear surface portion 60B of the upper cover 60 in a configuration in which the upper surface operation dial 50 is operated by being rotated around an axis orthogonal to the upper surface portion 60T of the upper cover 60. Accordingly, the upper surface portion 60T of the upper cover 60 can be flattened. That is, the upper surface operation dial 50 can be disposed without being exposed at the upper surface portion 60T of the upper cover 60.

As described above, according to the present embodiment, a rotary operation dial (the upper surface operation dial 50) can be installed without being exposed at the upper surface portion (= the upper surface portion 60T of the upper cover 60) of the camera body 1. Accordingly, it is possible to add a new dial operation system to the camera body 1 while achieving both of size reduction achieved by reduction in height and designability. In particular, in the present embodiment, the operation dial is disposed by using a space between the finder portion and the accessory attachment portion in a configuration in which the finder portion and the accessory attachment portion are disposed at the camera body 1 to be horizontally arranged, and thus it is possible to add a new dial operation system without a significant increase in size. That is, it is possible to add a new dial operation system while effectively utilizing a portion that becomes a dead space in a case where nothing is disposed.

In addition, regarding the upper surface operation dial 50 of the present embodiment, how the upper surface operation dial 50 has been set is checked via the window portion 61 provided at the upper surface portion 60T of the upper cover 60 in a configuration in which various types of setting operations are performed by aligning the icons Ic1 to Ic10 printed on the disc surface 51 with the indicator 81. Accordingly, even in such a configuration, the upper surface operation dial 50 can be disposed without being exposed at the upper surface portion 60T of the upper cover 60.

In particular, in the present embodiment, since the indicator 81 is also disposed inside the upper cover 60, it is not necessary to separately provide an indicator on the upper cover 60 side. Accordingly, the configuration of the upper cover 60 can be simplified.

Meanwhile, since the upper surface operation dial 50 and the indicator 81 are disposed inside the upper cover 60 together with each other, the indicator 81 can be disposed close to the upper surface operation dial 50. Accordingly, it is possible to easily check the state of setting and to improve the operability.

In addition, a configuration in which the inclined surface 52 of the peripheral edge of the disc surface 51 is covered with the decorative plate 80 in the window portion 61 is provided with respect to the upper surface operation dial 50 including the inclined surface 52 (the chamfered portion) provided at the peripheral edge of the disc surface 51. Accordingly, the size of a gap between the decorative plate 80 and the upper surface operation dial 50 can be reduced, so that the icons Ic1 to Ic10 can be easily aligned with the indicator 81. In addition, accordingly, improvement in appearance quality can be achieved.

In addition, the upper surface operation dial 50 of the present embodiment includes the foreign matter infiltration suppressing mechanism 90 that suppresses infiltration of a foreign matter into the window portion 61 in a configuration in which the window portion 61 includes the window member 63. Accordingly, infiltration of a foreign matter into the tightly closed window portion 61 can be suppressed. In particular, in the present embodiment, the first guard member 91 is configured to surround a region including the shaft portion 51A in a configuration in which the shaft portion 51A protruding from the disc surface 51 is provided, and thus infiltration of sliding powder or the like into the window portion 61 can be effectively suppressed even in a case where the sliding powder or the like is generated at the shaft portion 51A.

In addition, regarding an installation portion for the upper surface operation dial 50, the camera body 1 of the present embodiment includes the recess portion 60G provided at the upper cover 60 and the recess portion 60G is provided with the opening portion 62 such that the upper surface operation dial 50 is partially exposed. Accordingly, the operability of the upper surface operation dial 50 can be improved. In addition, since the eye sensor 23 is disposed outside the recess portion 60G, a finger operating the upper surface operation dial 50 can be made less likely to be hooked on the eye sensor 23 in a case where the upper surface operation dial 50 is operated. Accordingly, malfunction of the eye sensor 23 can be suppressed.

### Modification Examples

### Operation Dial

The upper surface operation dial 50 of the above-described embodiment is configured such that various types of setting operations are performed by aligning the icons Ic1 to Ic10 printed on the disc surface 51 with the indicator 81. However, an example of the operation dial is not limited thereto. For example, the operation dial can be configured such that a predetermined operation is input by means of the amount of rotation or the number of clicks and a rotation direction. In this case, a window portion for checking the setting is not necessary.

In addition, the operation dial may be configured such that the operation dial can be operated by being rotated and can be operated by being pressed. For example, the operation dial may be configured such that the operation dial can be operated by being pressed in a direction orthogonal to a rotation axis.

In addition, the purpose of use of the operation dial can be appropriately set in accordance with the functions and the like of a device into which the operation dial is incorporated.

### Window Portion

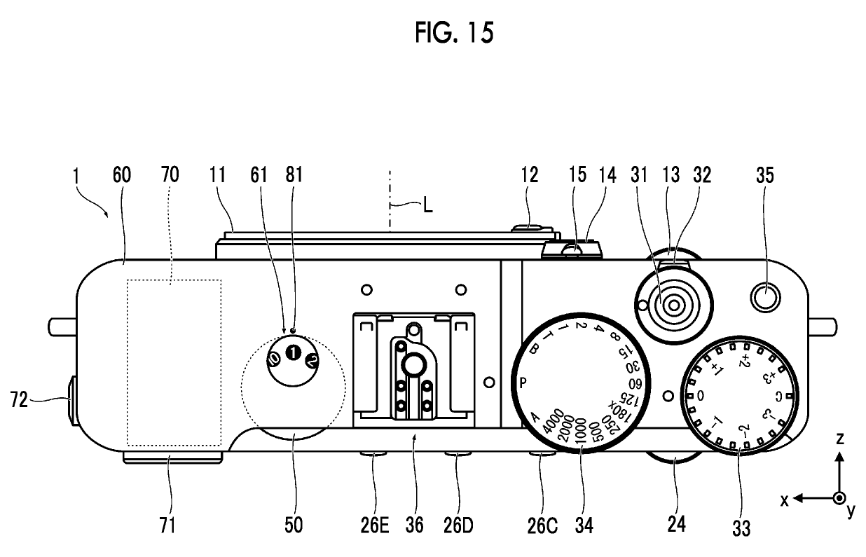

FIG. 15 is a plan view showing another example of the window portion provided at the upper surface portion of the upper cover.

FIG. 15 shows an example of a configuration in which only the disc surface 51 of the upper surface operation dial 50 is visible through the window portion 61. In this case, the indicator 81 is provided at the upper surface portion 60T of the upper cover 60. In addition, in this case, a decorative plate serving as an outer peripheral member is not necessary.

The size and shape of the window portion 61 are not particularly limited. It is preferable to appropriately set the size and shape of the window portion 61 in consideration of visibility, design, and the like. Note that in a case where the minimum necessary size (a size equal to or smaller than the size of the disc surface of the operation dial at least) is adopted, the rigidity of the upper cover 60 can be ensured.

### Decorative Plate

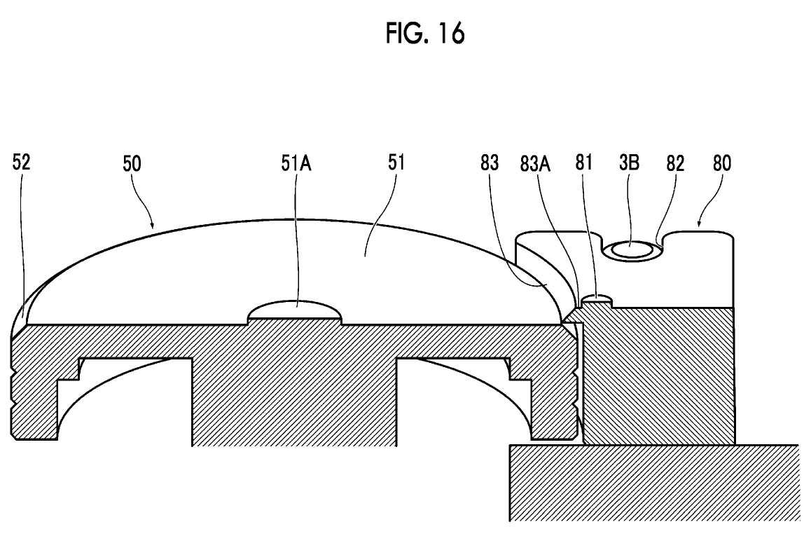

FIG. 16 is a perspective half cross-sectional view showing another example of the decorative plate.

In the above-described embodiment, the upper surface 80T of the decorative plate 80 is configured to be flush with the disc surface (the upper surface) 51 of the upper surface operation dial 50. However, as shown in FIG. 16, a configuration in which the upper surface 80T is disposed with a level difference may also be adopted. Accordingly, it is possible to configure the three-dimensional disc surface 51 including the decorative plate 80.

### Foreign Matter Infiltration Suppressing Mechanism

In the above-described embodiment, a configuration in which the two guard members, which are the first guard member 91 and the second guard member 92, are disposed as the foreign matter infiltration suppressing mechanism is adopted. However, a configuration in which only one guard member is disposed may also be adopted.

In addition, in the above-described embodiment, the foreign matter infiltration suppressing members (the first guard member 91 and the second guard member 92) are formed of a foaming body (a foaming material). However, the material of the foreign matter infiltration suppressing members is not limited thereto. In addition, for example, a flocked sheet, a nonwoven fabric, or the like can be adopted. The flocked sheet is a member obtained by attaching (flocking) fibers (for example, chemical fibers) to a surface of a sheet in an upright state. The flocked sheet is an example of a flocked member.

### Other Modification Examples

In the above-described embodiment, a case where the present invention is applied to a lens-interchangeable digital camera has been described as an example. However, the application of the present invention is not limited thereto. The present invention can also be applied to a lens-integrated camera (a camera in which a lens is integrally provided with a camera body).

In addition, in the above-described embodiment, the hot shoe 36 is disposed on the substantially same plane as a plane on which the window portion 61 is disposed. However, there may be a level difference between a plane on which the window portion 61 is disposed and a plane on which the hot shoe 36 is disposed.

In addition, it is preferable that the upper surface operation dial 50 shares a wiring board with other operation dials in the camera body 1.

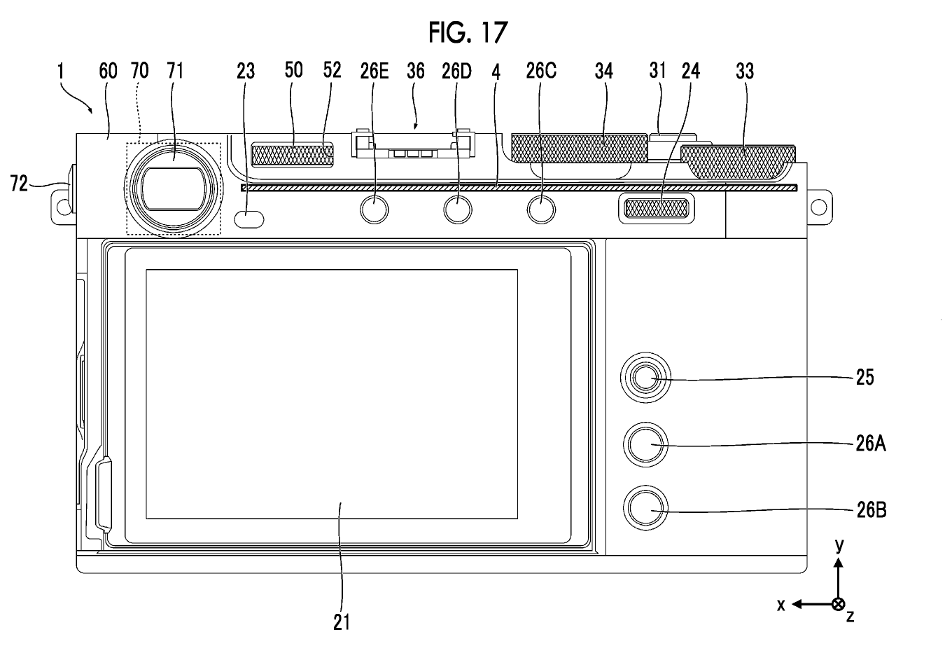

FIG. 17 is a conceptual view of the way in which the wiring board is shared.

In an example shown in FIG. 17, an example of a case where a wiring board 4 is shared by the upper surface operation dial 50, the exposure correction dial 33, and the shutter speed dial 34 is shown. The wiring board 4 is provided with, for example, a brush pattern for each operation dial. As described above, in a case where one wiring board 4 is shared by a plurality of operation dials, the configuration can be simplified.

### Supplementary Note

In the present specification, the meanings of the terms "the same" and "identical" include not only a meaning of "completely identical" but also a meaning of "substantially the same" including an error allowed in design and manufacturing.

In addition, in the present specification, the meaning of the term "orthogonal" includes not only a meaning of "completely orthogonal" but also a meaning of "substantially orthogonal" including an error allowed in design and manufacturing.

In addition, in the present specification, the meaning of the term "parallel" includes not only a meaning of "completely parallel" but also a meaning of "substantially parallel" including an error allowed in design and manufacturing.

In addition, in the present specification, the meaning of the term “constant” includes not only a meaning of "completely constant" but also a range recognized as substantially constant (a meaning of "substantially constant").

### Explanation of References

1: camera body

2: interchangeable lens

3: internal frame

3A: dial installation portion

3B: positioning pin

4: wiring board

11: lens mount

12: lens detachment button

13: front surface operation dial

14: front surface operation button

15: front surface operation lever

16: AF auxiliary light lamp

21: rear surface monitor

23: eye sensor

23A: sensor window portion

23B: light emitting unit

23C: light receiving unit

24: rear surface operation dial

25: rear surface operation lever

26A: first rear surface operation button

26B: second rear surface operation button

26C: third rear surface operation button

26D: fourth rear surface operation button

26E: fifth rear surface operation button

31: shutter button

32: power lever

33: exposure correction dial

34: shutter speed dial

35: upper surface operation button

36: hot shoe

41: terminal cover

50: upper surface operation dial

51: disc surface of upper surface operation dial

51A: shaft portion of upper surface operation dial

52: inclined surface of peripheral edge of disc surface of upper surface operation dial

60: upper cover

60B: rear surface portion of upper cover

60G: recess portion of upper cover

60T: upper surface portion of upper cover

61: window portion

61A: window opening portion of upper cover

62: opening portion of upper cover

63: window member

63A: window body portion of window member

63B: flange portion of window member

63B1: flange portion body

63B2: protruding portion

70: finder unit

71: eyepiece portion

72: diopter adjustment dial

80: decorative plate

80T: upper surface of decorative plate

81: indicator

82: notch portion of decorative plate

83: arc portion of decorative plate

83A: projecting portion of arc portion of decorative plate

83B: inclined surface of arc portion of decorative plate

90: foreign matter infiltration suppressing mechanism

91: first guard member

91A: large-diameter portion of first guard member

91B: small-diameter portion of first guard member

92: second guard member

Ic1: icon

Ic10: icon

Ic2: icon

Ic3: icon

Ic4: icon

Ic5: icon

Ic6: icon

Ic7: icon

Ic8: icon

Ic9: icon

L: imaging optical axis

D: distance from rotation center of upper surface operation dial to window portion

r: inner radius of small-diameter portion of first guard member

What is claimed is:

1. An imaging apparatus comprising:
a cover member that includes at least a first surface portion and a second surface portion intersecting the first surface portion;
an accessory attachment portion provided at the first surface portion of the cover member;
a finder portion in which an eyepiece portion is disposed at the second surface portion of the cover member; and
an operation dial that is disposed between the accessory attachment portion and the finder portion, that is operated by being rotated around an axis intersecting the first surface portion, and that is partially exposed through an opening portion provided at the second surface portion of the cover member.

2. The imaging apparatus according to claim 1,
wherein the cover member includes a recess portion provided at the second surface portion, and
the opening portion is provided at the recess portion.

3. The imaging apparatus according to claim 2,
wherein the recess portion extends in a direction intersecting a rotation axis of the operation dial.

4. The imaging apparatus according to claim 2, further comprising:
a sensor unit that detects use of the eyepiece portion, the sensor unit being provided at the second surface portion of the cover member,
wherein the sensor unit is disposed outside the recess portion.

5. The imaging apparatus according to claim 4,
wherein the sensor unit includes a light emitting unit and a light receiving unit, and
the light emitting unit and the light receiving unit are disposed to be arranged in a direction intersecting a rotation axis of the operation dial.

6. The imaging apparatus according to claim 1, further comprising:
a window portion through which a disc surface of the operation dial is visible, the window portion being provided at the first surface portion of the cover member.

7. The imaging apparatus according to claim 6, further comprising:
a transparent or translucent window member provided at the window portion.

8. The imaging apparatus according to claim 6,
wherein the window portion is disposed at a position separated from a rotation center of the operation dial.

9. The imaging apparatus according to claim 6, further comprising:
an outer peripheral member that is disposed at an outer periphery of the operation dial in the cover member and that is visible through the window portion together with the operation dial.

10. The imaging apparatus according to claim 9,
wherein the outer peripheral member includes an indicator for the operation dial.

11. The imaging apparatus according to claim 9,
wherein the outer peripheral member includes a covering portion that covers at least a part of the operation dial.

12. The imaging apparatus according to claim 11,
wherein the operation dial includes an inclined surface provided at a peripheral edge of the disc surface, and
the covering portion covers the inclined surface at least in a region visible through the window portion.

13. The imaging apparatus according to claim 9,
wherein at least a region of the outer peripheral member that is visible through the window portion is composed of a surface aligned with the disc surface of the operation dial.

14. The imaging apparatus according to claim 6, further comprising:
foreign matter infiltration suppressing members that suppress infiltration of a foreign matter into the window portion, the foreign matter infiltration suppressing members being provided between the cover member and the operation dial.

15. The imaging apparatus according to claim 14,
wherein the foreign matter infiltration suppressing members include at least one of a first foreign matter infiltration suppressing member that surrounds a periphery of the window portion or a second foreign matter infiltration suppressing member that blocks a gap of the opening portion.

16. The imaging apparatus according to claim 15,
wherein the first foreign matter infiltration suppressing member has a frame-like shape that surrounds a region including a shaft portion of the operation dial.

17. The imaging apparatus according to claim 16,
wherein the first foreign matter infiltration suppressing member includes
a first frame portion that surrounds the periphery of the window portion, and
a second frame portion that surrounds a periphery of the shaft portion of the operation dial, and
a distance from a rotation center of the operation dial to an inner periphery of the second frame portion is smaller than a distance from the rotation center of the operation dial to the window portion.

18. The imaging apparatus according to claim 14,
wherein the foreign matter infiltration suppressing member is composed of a flocked member, a nonwoven fabric, or a foaming body.

19. The imaging apparatus according to claim 1,
wherein the cover member includes a third surface portion that intersects the first surface portion and the second surface portion, and
the imaging apparatus further comprises a diopter adjustment dial for adjustment of a diopter of the finder portion, the diopter adjustment dial being provided at the third surface portion of the cover member.

20. The imaging apparatus according to claim 1,
wherein the accessory attachment portion and the finder portion are disposed to be arranged in a direction intersecting an imaging optical axis.

21. An imaging apparatus comprising:
a cover member that includes at least a first surface portion and a second surface portion intersecting the first surface portion; and
an operation dial that is operated by being rotated around an axis intersecting the first surface portion and that is partially exposed through an opening portion provided at the second surface portion of the cover member,
wherein the cover member includes a window portion through which a disc surface of the operation dial is visible, the window portion being provided at the first surface portion.
